(19) United States
(12) Patent Application Publication
(10) Pub. No.: US 2023/0182054 A1
(43) Pub. Date: Jun. 15, 2023

(54) POCKET FILTER ASSEMBLY AND METHOD FOR INSTALLATION

(71) Applicant: Freudenberg Filtration Technologies LP, Hopkinsville, KY (US)

(72) Inventors: Donald N. Jursich, Crystal Lake, IL (US); Daniel E. Schuld, Inverness, IL (US)

(21) Appl. No.: 18/167,313

(22) Filed: Feb. 10, 2023

Related U.S. Application Data
(62) Division of application No. 16/985,395, filed on Aug. 5, 2020.

(51) Int. Cl. B01D 46/00; B01D 46/121

(52) U.S. Cl. CPC B01D 46/0006; B01D 46/121; B01D 2265/028

(57) ABSTRACT

A method of installing a filter assembly in a return duct of a furnace, where the method includes selecting a location on the return duct to install the filter assembly, cutting a slot into a front surface of the return duct, mounting at least one rail to an interior side surface of the return duct, where the at least one rail defines a receiving structure, inserting a header frame into the receiving structure such that the header frame is slidable between an open position and closed position with respect to the return duct and placing at least one pocket filter into engagement with the header frame.

### CROSS-REFERENCE TO RELATED APPLICATIONS

This application is a divisional of and claims priority to U.S. patent application Ser. No. 16/985,395 filed on Aug. 5, 2020, the entire contents of which is incorporated herein by reference.

### FIELD OF THE INVENTION

This invention relates to filters that remove particulates as air is circulated through a forced air furnace. More specifically, an improved filter assembly is provided for the consumer to assemble in the return duct of a furnace to enable it to accommodate a filter having an increased filtration capacity.

### BACKGROUND

To reduce recirculation of particulate matter through the air, furnaces are equipped with a filter on the cold air return duct. The filter screens dirt, dust and other solid materials from the air, keeping the furnace cleaner and recirculating cleaner air to the space being heated. Furnace filters come in hundreds of different sizes to accommodate various manufacturers and models of furnaces, however the most common form of the furnace filter is a pleated box filter. Particulate matter builds up on the filter, making it necessary to replace the filter every few months with the same type of replacement filter that is specified by the furnace manufacturer.

The media inside the filter traps the airborne particles. The effectiveness of a media is assigned a Minimum Efficiency Reporting Value (MERV rating), where the higher the MERV rating of a filter, the fewer the particles than can pass through it. Presently, the highest rated media that can be accommodated on a pleated box filter is MERV 13. While MERV 13 is highly effective at removal of airborne particles in most instances, higher MERV values may assist in the removal of allergens and airborne viral particulate. However, medias having higher MERV ratings are typically too thick and not conducive to being incorporated on the pleated box filters that are received in home furnaces.

### SUMMARY OF THE INVENTION

A filter assembly for mounting on a side interior surface of a horizontal or vertical return duct of a furnace includes at least one pocket filter having a retaining collar at its peripheral surface. The filter assembly also includes a frame. The frame has a header frame with multiple frame members forming an open framework defining at least one receiving area for receiving the pocket filter. The retaining collar attaches to or engages at least one of the frame members. The frame also includes at least one rail that is mountable on the interior side surface of the return duct. The rail defines a receiving structure for receiving the header frame so that the header frame can be slidable on the rail from an open position to a closed position with respect to the duct.

Another embodiment of filter assembly for mounting on a side surface of a return duct of a furnace includes a pre-assembled cartridge having at least one pocket filter disposed on a header frame. The filter assembly also includes at least one rail that is mountable on the side surface of the return duct and defines a receiving structure for receiving the header frame. The header frame is slidable on the at least one rail from an open position to a closed position with respect to the duct. The filter assembly further includes a cover that has a width that is substantially the same width as the header frame. The cover is attachable to the header frame.

A method of installing a filter assembly in a return duct of a furnace includes selecting a location on the return duct to install the filter assembly, cutting a slot into a front surface of the return duct, and mounting at least one rail to an interior side surface of the return duct. The at least one rail defines a receiving structure. The method also includes inserting a header frame into the receiving structure such that the header frame is slidable between an open position and a closed position with respect to the return duct. The method further includes placing at least one pocket filter into engagement with the header frame.

### DETAILED DESCRIPTION OF THE DRAWINGS

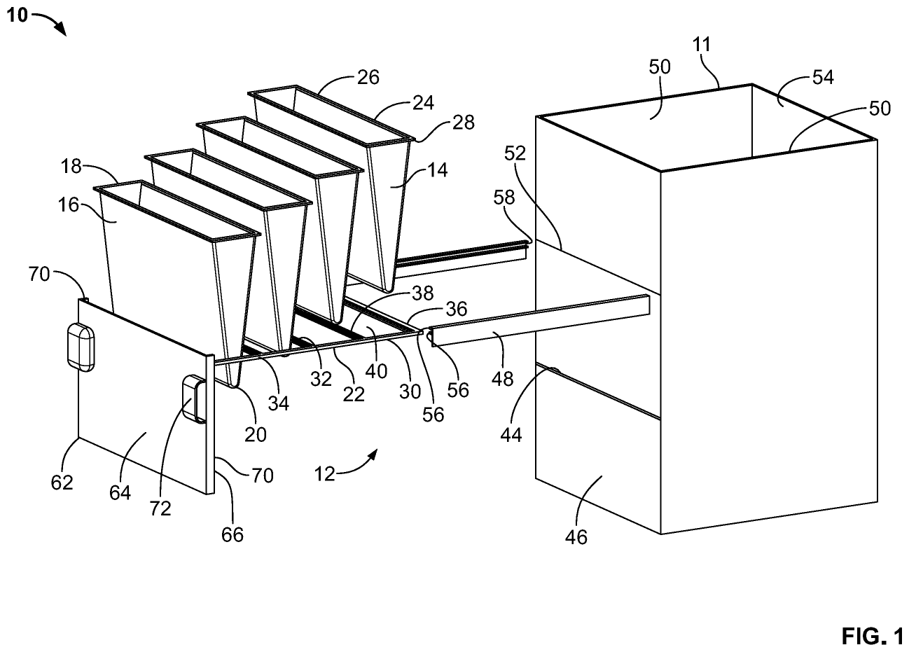

FIG. 1 shows an exploded side perspective view of a preferred filter assembly for installing in a return duct for a furnace;

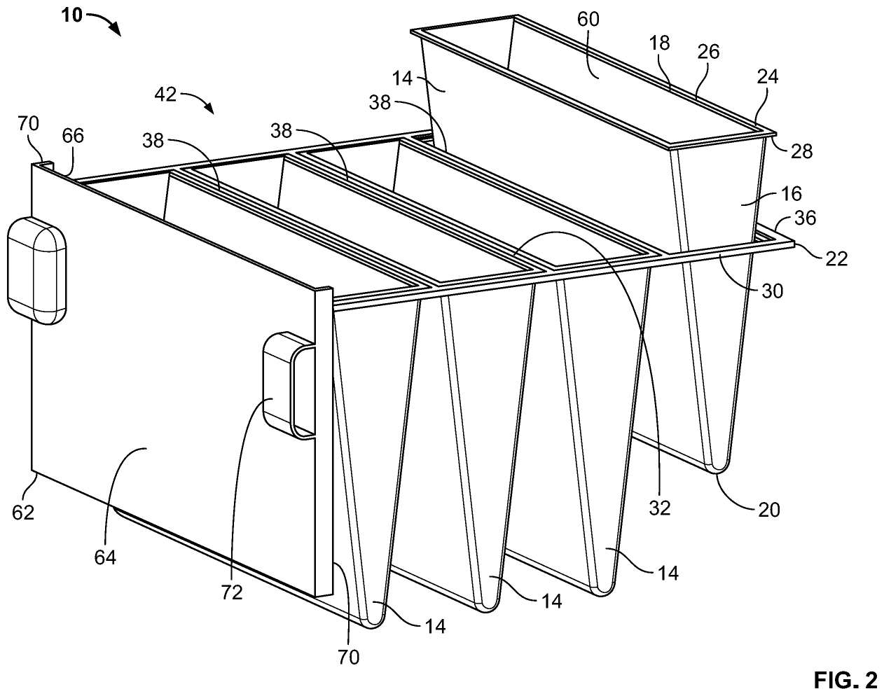

FIG. 2 shows a perspective view of the filter assembly of FIG. 1;

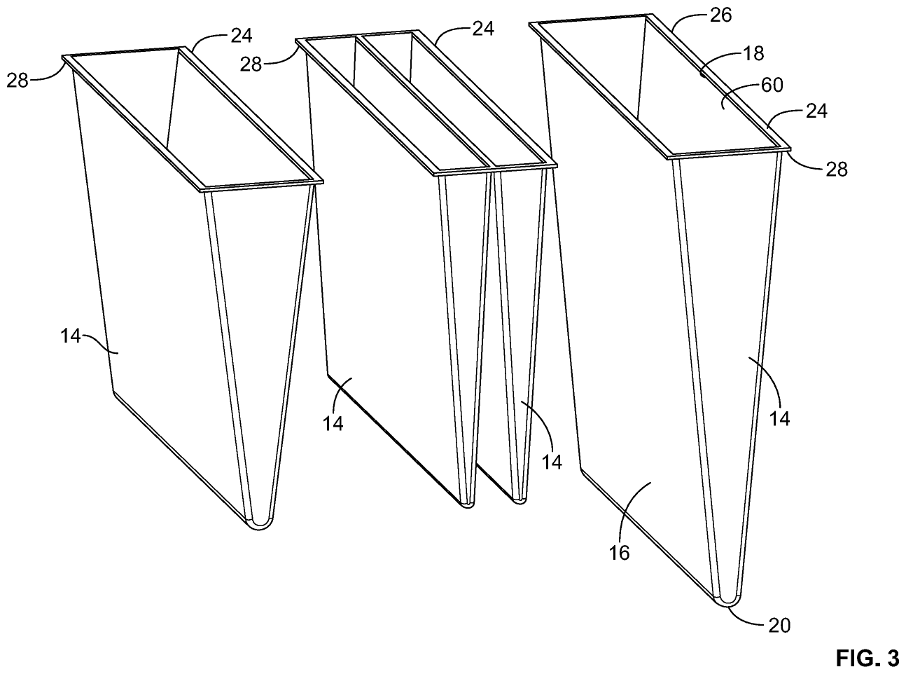

FIG. 3 shows a perspective view of different sizes and of pocket filters for the filter assembly of FIG. 1;

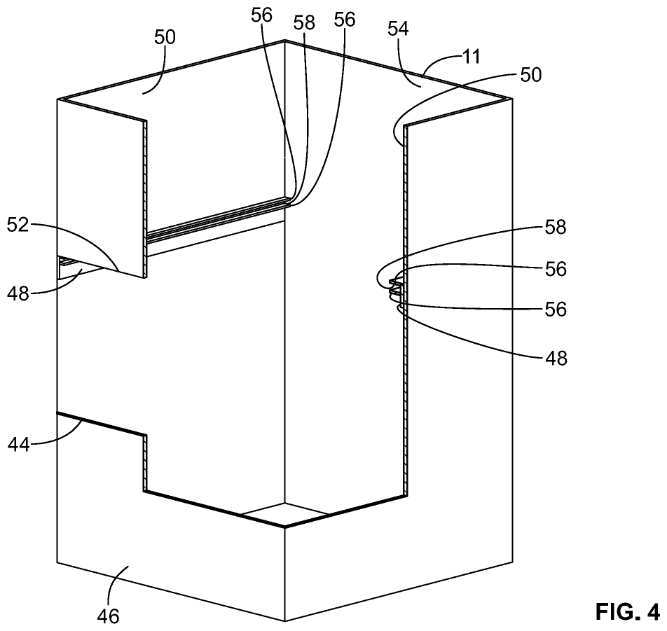

FIG. 4 shows a cut-away view of two rails of the filter assembly of FIG. 1 installed in the return duct of the furnace; and

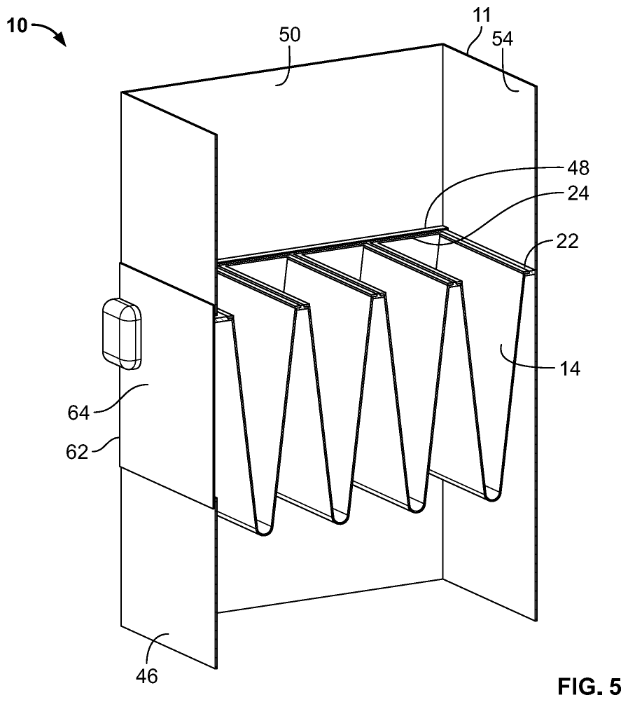

FIG. 5 shows a cross-section of the filter assembly of FIG. 1 installed in the return duct of the furnace.

### DETAILED DESCRIPTION OF THE INVENTION

As shown in FIGS. 1-5, an improved filter assembly is generally designated 10, and includes a frame 12 and at least one pocket filter 14 that is to be mounted in a return duct 11 of a furnace. The embodiment of FIGS. 1-5 is intended to serve as an example of the invention, but not to limit the invention in any way. Unless specified, directional references refer to the filter assembly 10 as oriented as in FIG. 1. Further, while the following description is made with reference to a vertical orientation of return duct 11, a horizontal orientation is also contemplated.

Most home furnaces use box filters having a MERV rating of no higher than 13. Replacement furnace filters are generally a rectangular panel having a thickness of approximately one inch, but varying in the size of the rectangular panel to fit perpendicularly across the direction of air flow within the duct. The box filters are disposed in filter cabinets attached to the duct work of the furnace. Although rectangular box filters are common in home furnaces, their construction is not conducive to higher MERV rated materials because the media becomes too think and heavy for the support wire structure of the box filter.

Furnace manufacturers design their filter cabinets to receive a particular type and size of box filter that fits within the interior shape of the filter cabinet, so owners are not able to easily substitute the box filters with filters having different sizes, shapes and thicknesses that are associated higher MERV values.

One such configuration of filter that can accommodate higher MERV values is the pocket filter 14. While pocket filters are known, they are not typically used in household forced air furnaces because they do not have a thin configuration that fits in the filter cabinets of the furnace. Instead, pocket filters 14 are generally known to have a body 16 that is sheath-like and generally tapered or wedge-shaped. The pocket filters 14 have a generally rectangular open end 18, and opposite the open end along the length of the body is a closed end 20.

In filter arrangements of this type, it is desirable to minimize contact between the adjacent pocket filters 14 to maintain a uniform flow of gases through the filters as well as to effectively utilize the entire area of the filter media in the filter bags. If this is not done, there can be a substantial pressure loss in the air stream as it flows through the filter cartridge and an increase in the energy required to operate the system. Separation between the adjacent filter bags 14 is obtained by shaping the body 16 in the tapered or wedge-shaped configuration from the open end 18 to the closed end 20.

In the filter assembly 10, there are a plurality of pocket filters 14 that are engaged or attached on a generally rectangular header frame 22. In the preferred embodiment, each pocket filter 14 has a generally rectangular retaining collar 24 on the open end 18. Specifically, the retaining collar 24 is preferably located on a peripheral surface 26 of the open end 18, and has an outwardly projecting lip 28 in the direction transverse to the length of the pocket filter 14 and in a direction generally outwardly projecting or radial to the center of the open end. The retaining collar 24 provides resistance to the collapse of the filter media by maintaining the open end 18 in an open position.

The header frame 22 has multiple frame members, including two parallel frame members 30, and a plurality of transverse frame members 32 interconnecting the parallel frame members forming an open framework 34. In the preferred embodiment, there are two exterior transverse frame members 36, and three interior transverse frame members 38 that define receiving areas 40 therebetween for receiving four pocket filters 14. The four pocket filters 14 are assembled into the header frame 22 in a side-by-side relationship to form a filter cartridge 42. It should be appreciated that other numbers and arrangements of pocket filters 14 on a header frame 22 are contemplated. Additionally, the MERV value of the pocket filters 14 can be the same or different. Further, the sizing of each of the four pocket filters 14 can be uniform or different, and some of the pocket filters may be connected to adjacent pocket filters, for example with a common retaining collar. Further still, the pocket filters 14 may come pre-assembled with the header frame, such as in a cartridge arrangement. The size, number, configuration and MERV values of the pocket filters 14 can vary, as long as there is sufficient airflow through the filter 10 to efficiently remove the desired particulates from the air without significantly impeding the airflow through the furnace. However, the pocket filters 14 allow the consumer to take advantage of the larger MERV values assigned to pocket filters as compared to box filters, including MERV values as high as MERV 16.

The header frame 22 supports the pocket filters 14 so that they are spaced in the duct 11. In use, the header frame 22 is mounted within the gas flow path in the return duct 11 with the open end 18 of the pocket filters 14 on the upstream end, such that gas to be filtered enters the open ends, flows into the pocket filters, and passes through the pores of the filter media comprising the body 16 of the pocket filters. The header frame 22 is sized to generally span the cross-sectional area of the return duct 11, and as such sizing can vary widely depending on the furnace duct receiving the filter assembly 10. Typical example sizes of ducts 11 range from about 12″×20″ to about 20″×32″.

Since the return duct 11 has no existing mounting structure (it is a smooth duct), when the consumer purchases the filter assembly 10, the frame 12 includes components that need to be installed in the furnace return duct 11. Specifically, a slot 44 is cut into a front surface 46 of the duct 11, and the header frame 22 and the pocket filters 14 are mounted in the furnace return duct 11 on at least one rail 48. In the preferred embodiment, two rails 48 are mounted on opposing interior side surfaces 50 of the furnace intake duct 11 that are perpendicular to the front surface 46 of the duct, and at a height that aligns with or is slightly below a top edge 52 of the slot 44. Preferably, the rails 48 extend the entire length of the side surfaces 50, extending from the front surface 46 to a rear surface 54. Fasteners (not shown), such as screws and washers, may be provided as part of the filter assembly 10 for mounting the rails 48 to the interior side surfaces 50 of the duct 11.

The rails 48 each include two inwardly protruding ridges 56 that define receiving structures, preferably longitudinal channels 58, for slidably receiving the header frame 16. The receiving structures 58 allow the header frame to be slid from an open position to a closed position with respect to the return duct 11. Each of the receiving structures 58 define a receiving plane that is generally perpendicular to the flow of air through the duct 11. When the header frame 22 is in the closed position, it resides in the receiving plane to capture the particulars in the flow of air through the duct.

It is contemplated that the rails 48 can define other receiving structures than longitudinal channels 58, such as channels without a continuous ridge 56, for example with protrusions or discontinuous ridges. It is also contemplated that other receiving structures for receiving the header frame 16 that can be mounted within the return duct 11 without continuous rails 48.

The widths of the longitudinal channels 58, as taken in the direction between the two ridges 56, are sized to accommodate the thickness of the parallel frame members 30 of the header frame 22 such that the header frame can be slidably received in the channels 58. It is also contemplated that the channels 58 are sized such that the header frame 22 and the 28 lip of the retaining collar 24 are both slidably received in the channels.

The frame members 12 and rails 48 of the frame 12 are preferably constructed from a single, die-cut or extruded piece of material. Any material is usable for the frame 12 and the retaining collar 24 if it provides sufficient structural strength to hold the shape of the pocket filter 14 as air is forced through it over the reasonable lifetime of the filter. Preferred materials include, but are not limited to plastic, metals, and wood.

While the pocket filters 14 shown in FIGS. 1-5 are shown representationally, it should be appreciated by those skilled in the art that the filter media 60 resides within the pocket body 16 to trap particulate matter passing therethrough. Typically, the media is designed with a 2-3 layer construction, are thick and meant to have strong particulate holding potential with an edge of the media being glued between two layers of chipboard. However, any type of material that does not significantly block airflow while simultaneously trapping particulates in the air is suitable for use as the filter media 60. In particular, commonly used MERV 14-16 media includes one layer of meltblown non-woven fabric.

The method of incorporating the filter assembly 10 includes selecting a location on the horizontal or vertical return duct 11 of the furnace, then cutting the slot 44 into the return duct at the selected location. While most filter cabinets provided by furnace manufacturers are floor level, with the present method the workman can decide where to locate the filter assembly 10. The selection of the location on the return duct 11 can be anywhere that the owner wants, and specifically can be at a location that is easily accessed. Following installation of the filter assembly 10, the slot 44 needs to be enclosed. Another component of the filter assembly 10 is a cover 62. The slot 44 should be sized to be generally the width and height of the cover 62 provided in the filter assembly 10.

The cover 62 is attachable to one of the exterior transverse members 36 of the header frame 22. It is also possible that the cover 62 is integrally formed with the header frame 22. When the cover 62 is attached to the header frame 22, the pocket filters 14 may be pre-loaded on the header frame, or alternatively the pocket filters may be loaded onto the header frame after attachment of the cover 62. The cover 62 has a front wall 64 with an interior surface 66 and an exterior surface 68 that extends downwardly and generally parallel with the pocket filters 14. The cover 62 is preferably sized to span the width of the header frame 22 between the parallel members 30, and therefore generally the width of the duct 11. The cover 62 is also preferably sized to have a length that is generally parallel to and the same as the length of the pocket filters 14. However, since the pocket filters 14 are pliable, it is not necessary for the cover 62 (and the corresponding slot 44 through which the pocket filters are fed through) to have the same length as the pocket filters.

The cover 62 preferably has two side walls 70 extending generally perpendicularly from the front wall 64 and generally parallel with the two frame members 30 of the header frame 22. When the cover 62 encloses the slot 44, the side walls 70 are preferably tucked within the duct 11 and adjacent to or abutting the opposing side surfaces 50 of the duct.

At least one handle 72 is preferably located on the exterior surface 68 of the cover 62 to assist in opening and closing the filter assembly 10 from the duct 11 along the rails 48. The cover 62 preferably seals the duct 11 so that return air remains in the duct. The cover 62 may be made out of plastic, however other materials are contemplated.

The workman inserts the header frame 22 into the channel 58 of each rail 48. The lip 28 of the retaining collar 24 may also be received in the channel. The pocket filters 14 are preferably loaded into the header frame 22 during insertion of the header frame on the rails 48, however it is contemplated that the pocket filters 14 can be added after insertion. It is also contemplated that any type of filter that can be releasably mounted to the header frame 14 and received in the rails 48 can be used.

The pocket filters 14 are replaceable as needed by sliding the filter assembly 10 to the open position with respect to the duct 11 so that the filters pockets are accessible. The retaining collars 24 can be disengaged from the header frame 22 and removed from the receiving areas 40 defined by the open framework 34.

The filter assembly 10 allows a customer to upgrade their furnace to use a filter with a higher MERV value than what is typically provided by the box filter, for example a MERV value about 13, and specifically a MERV value of 16. When purchased by the customer, the filter assembly 10 includes the frame 12, the pocket filters 14, and the cover 62, and preferably the accompanying fasteners, to install an improved filter in the return duct 11.

While particular embodiments of the filter assembly and the method of using it has been shown and described, it will be appreciated by those skilled in the art that changes and modifications may be made thereto without departing from the invention in its broader aspects as set forth in the claims.

What is claimed is:

1. A method of installing a filter assembly in a return duct of a furnace, comprising:
selecting a location on the return duct to install the filter assembly;
cutting a slot into a front surface of the return duct;
mounting at least one rail to an interior side surface of the return duct, the at least one rail defining a receiving structure;
inserting a header frame into the receiving structure such that the header frame is slidable between an open position and closed position with respect to the return duct; and
placing at least one pocket filter into engagement with the header frame.

2. The method of claim 1, wherein the at least one pocket filter is placed into engagement with the header frame prior to inserting the header frame into the receiving structure.

3. The method of claim 1, wherein the at least one rail comprises at least two rails each defining a receiving structure, further comprising the step of mounting each of the at least two rails in the duct such that the rails define a receiving plane for the header frame that is generally perpendicular to the flow of air through the duct.

4. The method of claim 1, wherein the receiving structure is a longitudinal channel.

5. The method of claim 1, further comprising the step of inserting the lip of the retaining collar into the receiving structure.

6. The method of claim 1, further comprising the step of attaching a cover to the header frame to enclose the slot when the header frame is slid into the closed position with respect to the return duct.
